(19) United States
(12) Patent Application Publication
(10) Pub. No.: US 2026/0030317 A1
(43) Pub. Date: Jan. 29, 2026

(54) COMPUTING A FRACTIONAL EXPONENTIONAL WITHIN A SOFTMAX ACTIVATION FUNCTION USING A MATRIX MULTIPLICATION HARDWARE ACCELERATOR

(71) Applicant: QUALCOMM Incorporated, San Diego, CA (US)

(72) Inventors: Eric Wayne MAHURIN, Austin, TX (US); Lucian CODRESCU, Austin, TX (US); Jinxia BAI, San Diego, CA (US); Ying Tung YEH, Austin, TX (US)

(21) Appl. No.: 18/782,238

(22) Filed: Jul. 24, 2024

(51) Int. Cl. G06F 17/16

(52) U.S. Cl. CPC G06F 17/16

(57) ABSTRACT

The present disclosure is directed to a method for computing a fractional exponential for a softmax activation function. The method includes applying a binary scaling operation to a plurality of logits to generate a plurality of scaled logits. The method further includes applying, by a hardware accelerator configured for matrix multiplication, a polynomial convert function to each of the plurality of scaled logits. The method further includes obtaining, via the hardware accelerator, feedback based on applying the polynomial convert function, the feedback comprising a fractional exponential for each of the plurality of scaled logits.

### BACKGROUND

A softmax activation function may be used in neural networks. For instance, the softmax activation function may be used in the output layer of a neural network that is used as a classification model. More specifically, the softmax activation may convert the output of a previous layer of the neural network into a probability distribution, where the output values of the softmax activation function can be interpreted as the probability of each class of a plurality of classes associated with the classification model. To generate the output values, the softmax activation function generally computes a fractional exponential for each of the plurality of real-valued inputs (e.g., output of the previous layer of the classification model) and divides the computed fractional exponential for each of the plurality of real-valued inputs by the sum of the computed fractional exponential for each of the real-valued inputs. By dividing the fractional exponential for a given real-valued input by the sum of the fractional exponentials for each of the real-valued inputs, the output values of the softmax function are normalized (e.g., between 0 and 1) to make them interpretable as probabilities.

### BRIEF SUMMARY

Certain aspects provide a method for computing a fractional exponential within a softmax activation function. The method generally includes: applying a binary scaling operation to a plurality of logits to generate a plurality of scaled logits; applying, by a hardware accelerator configured for matrix multiplication, a polynomial convert function to each of the plurality of scaled logits; and obtaining, via the hardware accelerator, feedback based on applying the polynomial convert function, the feedback comprising a fractional exponential for each of the plurality of scaled logits.

Other aspects provide a hardware accelerator for computing a fractional exponential. The hardware accelerator generally includes a systolic array including a plurality of systolic stages, with each of the plurality of systolic stages including a plurality of processing elements, and with each of the processing elements including a multiplier and an accumulator. Furthermore, the hardware accelerator may be configured to: apply a binary scaling operation to a plurality of logits to generate a plurality of scaled logits; apply a polynomial convert function to each of the plurality of scaled logits; and obtain feedback based on applying the polynomial convert function, with the feedback comprising a fractional exponential for each of the plurality of scaled logits.

The following description and the related drawings set forth in detail certain illustrative features of one or more aspects.

### BRIEF DESCRIPTION OF THE DRAWINGS

The appended figures depict certain features of one or more aspects of the present disclosure and are therefore not to be considered limiting of the scope of this disclosure.

FIG. 1 depicts a softmax layer of a transformer model according to various aspects of the present disclosure.

FIG. 2 depicts a heterogeneous computing system according to various aspects of the present disclosure.

FIG. 3 depicts a systolic array included in a hardware accelerator configured for matrix multiplication according to various aspects of the present disclosure.

FIG. 4 depicts a block diagram of a hardware accelerator configured for matrix multiplication computing fractional exponentials within a softmax activation function according to various aspects of the present disclosure.

FIG. 5 depicts a method for computing a fractional exponential within a softmax activation function according to various aspects of the present disclosure.

FIG. 6 depicts an example processing system in which a heterogeneous computing system may be included according to various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses and related methods for computing a fractional exponential within a softmax activation function.

As discussed above, the softmax activation function may be used to convert the output of a previous layer of a neural network into a probability distribution. The output may include a plurality of real-valued inputs (e.g., logits) and the fractional exponential (e.g., the numerator of the softmax activation function) of each of the real-valued inputs (e.g., logits) may typically be computed in software as opposed to hardware. However, computing the fractional exponential within the softmax activation function using software diminishes (or at least reduces) the performance of the neural network as the throughput of the neural network is typically lower due to the amount of time it takes to compute the fractional exponential in software.

Example aspects of the present disclosure are directed to computing the fractional exponential within the softmax activation function using a hardware accelerator. More specifically, the present disclosure is directed to techniques for configuring a hardware accelerator configured for matrix multiplication to compute the fractional exponential within the softmax activation function. By using the hardware accelerator configured for matrix multiplication to compute the fractional exponential within the softmax activation function, the performance of the neural network may be improved as an amount of time it takes to compute the fractional exponential may be minimized thereby leading to an increase in the throughput of the neural network.

### Example Softmax Layer of Transformer Model

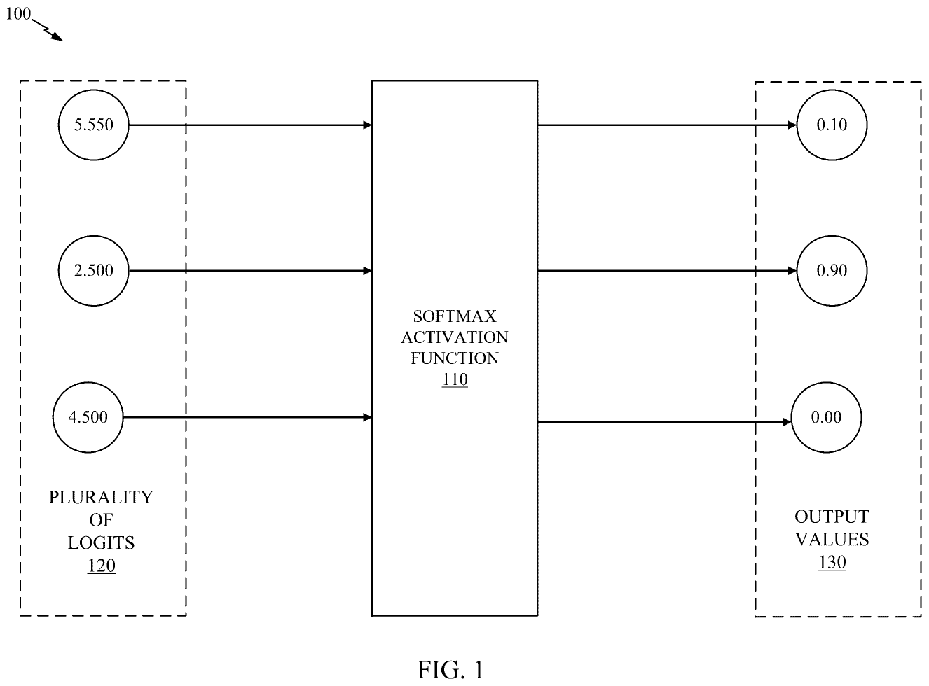

FIG. 1 depicts a softmax layer 100 of a transformer model according to some embodiments of the present disclosure. In some aspects, the transformer model may be used in neural networks. However, it should be understood that the scope of the present disclosure is not intended to be limited to use of the transformer model in neural networks and therefore the scope of the present disclosure may cover use of the transformer model in other types of machine learning models.

The softmax layer 100 includes a softmax activation function 110. As discussed above, the softmax activation function 110 may be used to convert a plurality of logits 120 (e.g., output by a previous layer of the transformer model) into a probability distribution, where the output values 130 of the softmax activation function 110 can be interpreted as the probability of each class. In some aspects, the softmax activation function 110 may be defined by the following formula:

$$softmax ( {x}_{i} ) = \frac{{e}^{x i}}{\sum {e}^{{x}_{j}}}$$

where xᵢ corresponds to a respective logit of the plurality of logits 120 that represent the output from a previous layer of the transformer model. As used herein, a “logit” may refer to a real-valued number having an integer portion and a fractional portion. The integer portion may refer to a portion of the logit to the left of a decimal place, whereas the fractional portion may refer to a portion of the logit to the right of the decimal place.

The numerator of the softmax activation function 110 is the exponential function, e^{xi}. By computing the exponential for each respective logit of the plurality of logits 102, the softmax activation function 110 may, in some aspects, emphasize the larger valued logits and de-emphasize the lower-valued logits. In this manner, the softmax activation function 110 may produce a valid probability distribution over the multiple classes, where each of the output values 130 represents the relative likelihood of each class.

The denominator of the softmax activation function 110 is the sum of the exponential function, e^{xi}, computed for each of the plurality of logits 120. By dividing the fractional exponential for a given real-valued input by the sum of the fractional exponential for all of the real-valued inputs, the output values 130 of the softmax activation function 110 are normalized (e.g., between 0 and 1) to make them interpretable as probabilities.

### Example Heterogeneous Computing System

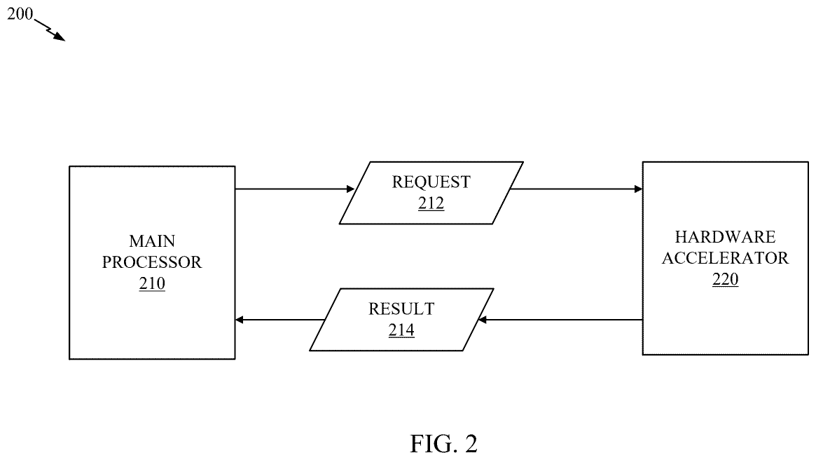

FIG. 2 depicts a heterogeneous computing system 200 according to aspects of the present disclosure. The heterogeneous computing system 200 may be used in a variety of different apparatuses (e.g., smartphones, tablets) and may be used for a variety of different applications (e.g., machine learning, digital signal processing, graphics processing). The heterogeneous computing system 200 includes a main processor 210 and a hardware accelerator 220. The main processor 210, which in some aspects may be a central processing unit (CPU), handles general-purpose computing tasks. The main processor 210 delegates computationally-intensive tasks, such as matrix multiplication, to the hardware accelerator 220. Examples of the hardware accelerator 220 may include, without limitation, a graphics processing unit (GPU), a neural processing unit (NPU), and a tensor processing unit (TPU).

As illustrated, the main processor 210 may send a request 212 to the hardware accelerator 220. The request 212 may, for example, be for the hardware accelerator 220 to perform a computationally intensive task (e.g., matrix multiplication) on data associated with a particular application (e.g., machine learning, digital signal processing) being executed by the heterogeneous computing system 200. The hardware accelerator 220 may communicate a result 214 of the computationally intensive task to the main processor 210. For example, in the case of matrix multiplication, the result 214 may include data resulting from the hardware accelerator 220 performing matrix multiplication on the data requested by the main processor 210.

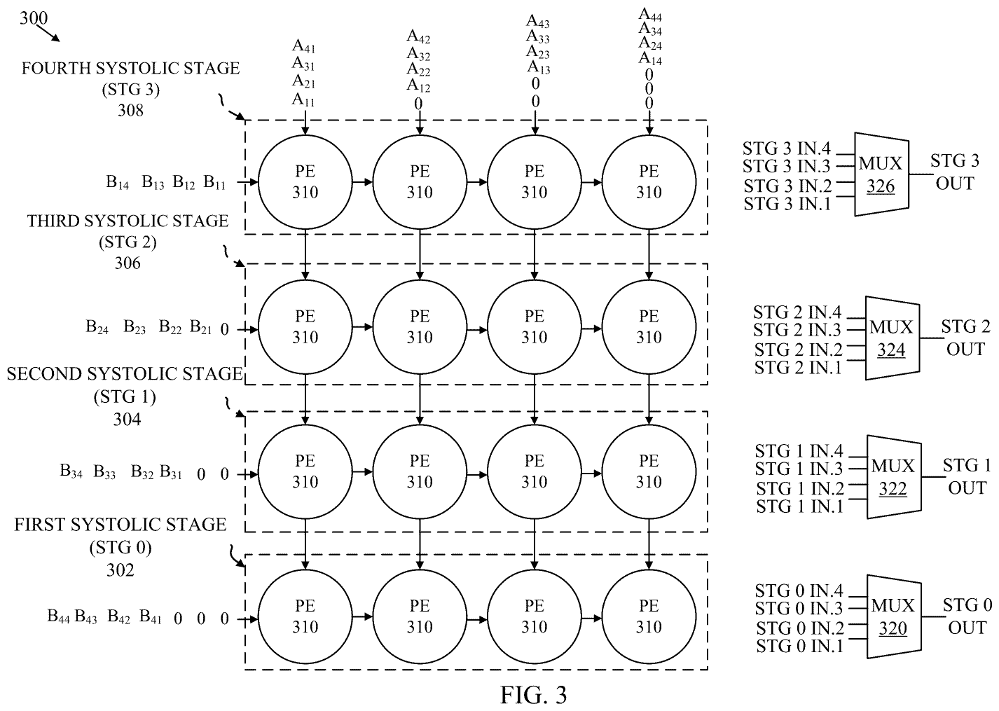

To perform the computationally intensive task, the hardware accelerator 220 may implement a parallel processing architecture. As will be discussed in more detail with reference to FIG. 3, the parallel processing architecture may include a systolic array. More specifically, the systolic array may be used to perform matrix multiplication. However, the systolic array may be used to perform other computationally intensive tasks besides matrix multiplication. Examples of other types of computationally intensive tasks that the systolic array may be configured to perform may include, without limitation, video processing tasks (e.g., filtering, edge detection, compression/decompression), digital signal processing tasks (e.g., discrete Fourier transform (DFT), convolution), cryptography tasks (e.g., modular arithmetic computations, elliptical curve computations).

### Example Systolic Array

FIG. 3 depicts a systolic array 300 according to some embodiments of the present disclosure. The systolic array 300 includes a plurality of systolic stages. For instance, in some aspects, the systolic array 300 may include a first systolic stage 302, a second systolic stage 304, a third systolic stage 306, and a fourth systolic stage 308. In other aspects, the systolic array 300 may include more or fewer systolic stages.

Each of the plurality of systolic stages may include a plurality of processing elements 310. For instance, as illustrated in FIG. 3, the first systolic stage 302, the second systolic stage 304, the third systolic stage 306, and the fourth systolic stage 308 may each include four processing elements 310. In other aspects, each of the plurality of systolic stages of the systolic array 300 may include more or fewer processing elements.

Each of the processing elements 310 may be configured to perform a computationally intensive task, such as matrix multiplication. Also, the systolic array 300 may have a grid structure (e.g, two-dimensional) that allows for the simultaneous execution of multiple matrix multiplication operations. For instance, as illustrated in FIG. 3, the grid structure may include multiple rows of processing elements 310 and multiple columns of processing elements 310. Furthermore, with a given row or column of the grid structure, each processing element 310 may be connected to its neighboring processing elements 310.

In some aspects, two input matrices (e.g., Matrix A and Matrix B) may be fed into the systolic array 300. For example, matrix elements (e.g., denoted as A ##) of Matrix A may be loaded into the systolic array 300 column-by-column, with each column of Matrix A entering the systolic array 300 through a different column of processing elements 310. Additionally, matrix elements (e.g., denoted as B ##) of Matrix B may be loaded into the systolic array 300 row-by-row, with each row of Matrix B entering the systolic array 300 through a different row of processing elements 310.

As the matrix elements flow through the systolic array 300, each respective processing element 310 may perform specific operations (e.g, multiply and accumulate) associated with matrix multiplication. More specifically, each respective processing element 310 may receive a matrix element from Matrix A and a matrix element from Matrix B. Each respective processing element 310 may multiply the two matrix elements and add (e.g., accumulate) a result of the multiplication to a partial sum stored in each processing element. This pipelined computation may continue as the matrix elements propagate through the systolic array 300 and a final result of the matrix multiplication may be obtained by collecting the output values from the systolic array 300. For instance, the accumulated result stored in each of the processing elements 310 may correspond to a different matrix element of a matrix (e.g., Matrix C) that is the result of multiplying Matrix A and Matrix B.

The transfer of matrix elements from one processing element 310 to its neighboring processing element 310 may be synchronized based on an input clock signal. For example, a matrix element in Matrix A may be passed (e.g., to the right) from one processing element 310 within a given row to another processing element 310 within the given row at the beginning of a clock cycle associated with the input clock signal. Additionally, a matrix element in Matrix B may be passed (e.g., down) from one processing element 310 within a given column to another processing element within the given column at the beginning of a clock cycle associated with the input clock signal.

As used herein, “clock cycle” may refer to a duration of time between two consecutive rising edges (or, alternatively, two consecutive falling edges) of the input clock signal. Thus, data may transfer from one processing element 310 to its neighboring processing element 310 when a current clock cycle of the input clock signal ends and a next clock cycle of the input clock cycle begins. In this manner, the rhythmic flow (e.g., similar to the systolic rhythm of a pumping action associated with a human heart) of the data through the systolic array 300 may be maintained.

In some aspects, the systolic array 300 may include a plurality of multiplexers. For example, the systolic array 300 may include a first multiplexer 320 associated with the first systolic stage 302 of the systolic array 300. The first multiplexer 320 may include a plurality of inputs (labeled as STG 0 IN. 1, STG 0 IN.2, STG 0 IN.3, STG 0 IN.4), with each of the plurality of inputs being coupled to a respective processing element 310 included in the first systolic stage 302 of the systolic array 300. In this manner, the first multiplexer 320 may receive the respective matrix element of Matrix C that each processing element 310 in the first systolic stage 302 calculated. Furthermore, the first multiplexer 320 may provide one of the plurality of inputs as an output (labeled STG 0 OUT).

In some aspects, the systolic array 300 may include a second multiplexer 322 associated with the second systolic stage 304 of the systolic array 300. The second multiplexer 322 may include a plurality of inputs (labeled STG 1 IN.1, STG 1 IN.2, STG 1 IN.3, STG 1 IN.4), with each of the plurality of inputs being coupled to a respective processing element 310 included in the second systolic stage 304 of the systolic array 300. In this manner, the second multiplexer 322 may receive the respective matrix element of Matrix C that each processing element in the second systolic stage 304 calculated. Furthermore, the second multiplexer 322 may provide one of the plurality of inputs as an output (labeled STG 1 OUT).

In some aspects, the systolic array 300 may include a third multiplexer 324 associated with the third systolic stage 306 of the systolic array 300. The third multiplexer 324 may include a plurality of inputs (labeled STG 2 IN.1, STG 2 IN.2, STG 2 IN.3, STG 2 IN.4), with each of the plurality of inputs being coupled to a respective processing element 310 included in the third systolic stage 306 of the systolic array 300. In this manner, the third multiplexer 324 may receive the respective matrix element of Matrix C that each processing element in the third systolic stage 306 calculated. Furthermore, the third multiplexer 324 may provide one of the plurality of inputs as an output (labeled STG 2 OUT).

In some aspects, the systolic array 300 may include a fourth multiplexer 326 associated with the fourth systolic stage 308 of the systolic array 300. The fourth multiplexer 326 may include a plurality of inputs (labeled STG 3 IN.1, STG 3 IN.2, STG 3 IN.3, STG 3 IN.4), with each of the plurality of inputs being coupled to a respective processing element 310 included in the fourth systolic stage 308 of the systolic array 300. In this manner, the fourth multiplexer 326 may receive the respective matrix element of Matrix C that each processing element in the fourth systolic stage 308 calculated. Furthermore, the fourth multiplexer 326 may provide one of the plurality of inputs as an output (labeled STG 3 OUT).

### Example Hardware Accelerator Computing Fractional Exponential

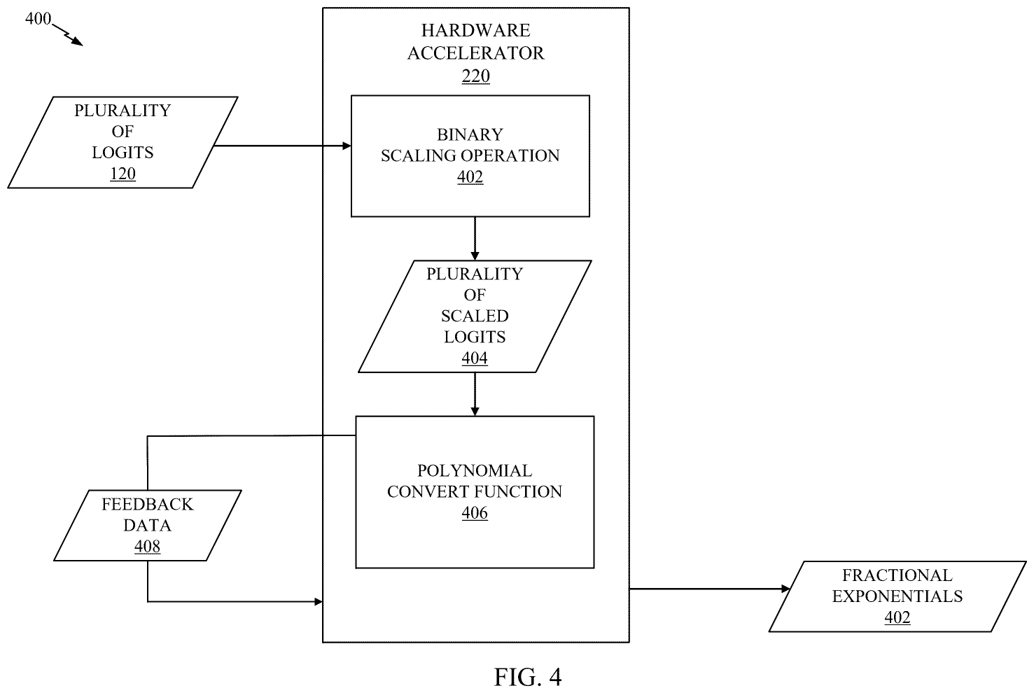

FIG. 4 depicts a block diagram 400 of the hardware accelerator 220 computing fractional exponentials 402 for each of the plurality of logits 120 according to some aspects of the present disclosure. The hardware accelerator 220 may include the systolic array 300 discussed above with reference to FIG. 3.

In some aspects, before computing the fractional exponential for each of the plurality of logits 120, a binary scaling operation may be applied to each of the plurality of logits 120. For example, one or more previous layers (e.g., layer involving matrix multiplication) of the transformer model that includes the softmax layer 100 discussed above with reference to FIG. 1 may perform constant scaling from base 10 to base 2. In this manner, an accumulator included in each processing element 310 (FIG. 3) of the systolic array 300 (FIG. 3) may apply the binary scaling operation (e.g., power-of-2 scaling base 2) to each of the plurality of logits 120 to generate a plurality of scaled logits 404.

In some aspects, the hardware accelerator 220 may be configured to apply a polynomial convert function 406 to each of the plurality of scaled logits 404. For example, in some aspects, the polynomial convert function 406 may be the softmax activation function 110 discussed above with reference to FIG. 1. In such aspects, the polynomial convert function 406 may be configured to convert each of the scaled logits 404 into a valid representation, such as a probability distribution (e.g., numerical value ranging from 0 to 1) across multiple classes in a classification model.

In some aspects, the polynomial convert function 406 may be configured to compute the fractional exponential for each of the plurality scaled logits 404. More specifically, the polynomial convert function 406 may be configured to compute the fractional exponential for the fractional portion (e.g., numbers to the right of the decimal place) of each of the plurality of scaled logits 404. Furthermore, in some aspects, the polynomial convert function 406 may be configured to compute the fractional exponential for the integer portion (e.g., numbers to the left of the decimal place) of each of the plurality of scaled logits 404.

To compute the fractional exponential for the fractional portion (e.g., numbers to the right of the decimal place) of each of the plurality of scaled logits 404 using the polynomial convert function 406, one or more operations may be performed. In some aspects, the one or more operations may be performed after a bias is applied to the accumulator of each of the processing elements 310 of the systolic array 300.

In some aspects, the one or more operations may include applying a shift to the accumulator included in each of the processing elements 310 of the systolic array 300 illustrated in FIG. 3. More specifically, a left-shift may be applied to the accumulator in each of the processing elements 310 of the systolic array 300 to discard the sign bit and one or more bits associated with the integer portion of the respective scaled logit 404 so that these bits, which typically cause an overflow, may be disregarded.

In some aspects, the one or more operations may include disabling data path shaping of the plurality of scaled logits 404. For example, such data path shaping operations that may be disabled to compute the fractional exponential for the plurality of scaled logits 404 may include, without limitation, input normalization, input scaling, and input shifting. Additionally, data path shaping that may be disabled may include modifying the gradients of the polynomial convert function 406 with respect to the inputs (e.g., the plurality of scaled logits 404).

In some aspects, the one or more operations may include activating a function of the hardware accelerator 220 associated with preventing the accumulator from being saturated while the left-shift is applied thereto. For instance, in some aspects, the function may be automatically activated in response to a sign bit associated with the data (e.g., scaled logit 404) stored in the accumulator changing to zero as a result of the left-shift.

In some aspects, the one or more operations may include configuring a rounding operation (e.g., jam rounding) associated with controlling the output probability distribution. For example, in some aspects, the rounding operation may be activated while computing the fractional exponential for each of the plurality of scaled logits 404. In alternative aspects, the rounding operation may be deactivated.

In some aspects, the one or more operations may include applying a bias to an output (that is, the fractional exponential for a respective scaled logit 404) of the polynomial convert function 406.

In some aspects, the one or more operations may include modifying a scale associated with the polynomial convert function 406. For instance, the scale associated with the polynomial convert function 406 may be modified based on the plurality of scaled logits 404 that are being provided as an input to the polynomial convert function 406 are base-2 fractional.

After performing the one or more operations described above, the polynomial convert function 406 may be applied to the plurality of scaled logits 404. Furthermore, the hardware accelerator 220 may receive feedback 408 from the polynomial convert function 406. In some aspects, the feedback 408 may include the fractional exponential for the fractional portion of each of the plurality of scaled logits 404.

In some aspects, the polynomial convert function 406 may be applied to the integer portion of the plurality of scaled logits 404. In such aspects, the hardware accelerator 220 may receive feedback from the polynomial convert function 406 and, in some aspects, the feedback may include the fractional exponential for the integer portion of each of the plurality of scaled logits 404.

By computing the fractional exponential within the softmax activation function using the hardware accelerator 220, the performance of the transformer model that the softmax activation function is included (e.g., in the softmax layer 100) may be improved because the fractional exponentials can be calculated in a more computationally-efficient manner. For example, by computing the fractional exponentials using the hardware accelerator 220 configured for matrix multiplication, the fractional exponentials can be computed faster compared to computing the same fractional exponentials using software. In this manner, a throughput of the transformer model may be increased as a result of the reduction in time associated with computing the fractional exponentials in the softmax layer thereof.

### Example Method of Operating a Systolic Array

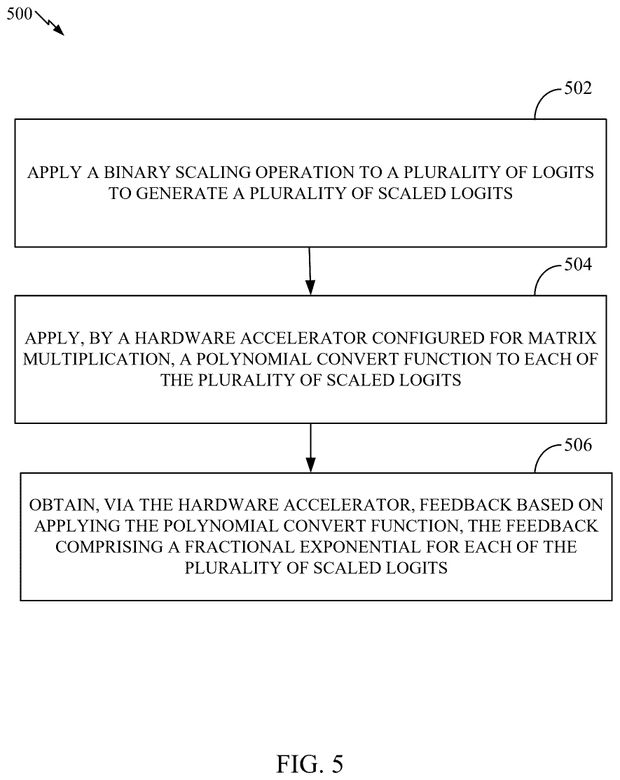

FIG. 5 is a diagram depicting an example method 500 of computing a fractional exponential within a softmax activation function according to various aspects of the present disclosure. For example, the method 500 may be performed by the hardware accelerator 220 of FIG. 4. Furthermore, although FIG. 5 depicts steps performed in a particular order for purposes of illustration and discussion, the method 500 discussed herein is not intended to be limited to any particular order or arrangement. One skilled in the art, using the disclosure provided herein, will appreciate that various steps of the method 500 can be omitted, rearranged, combined and/or adapted in various ways without deviating from the scope of the present disclosure.

At 502, the method 500 includes applying a binary scaling operation to a plurality of logits (e.g., logits 120 illustrated in FIG. 4) to generate a plurality of scaled logits (e.g., scaled logits 404 illustrated in FIG. 4). For example, a hardware accelerator (e.g., the hardware accelerator 220 illustrated in FIG. 4) configured for matrix multiplication may be further configured to implement the binary scaling operation (e.g., via accumulators included in the systolic array 300 of the hardware accelerator 220).

At 504, the method 500 includes applying a polynomial convert function to each of the plurality of scaled logits. For example, applying the polynomial convert function may include performing one or more of the actions described above with reference to FIG. 4.

At 506, the method 500 includes obtaining feedback based on applying the polynomial convert function to the plurality of scaled logits. For example, the feedback may include a plurality of fractional exponentials, with each of the plurality of fractional exponentials corresponding to a respective scaled logit of the plurality of scaled logits. For example, in some aspects, the plurality of fractional exponentials may have been computed for a fractional portion of each of the plurality of scaled logits. Thus, in such aspects, each of the plurality of fractional exponentials may correspond to the fractional portion of a respective scaled logit.

### Example Processing System

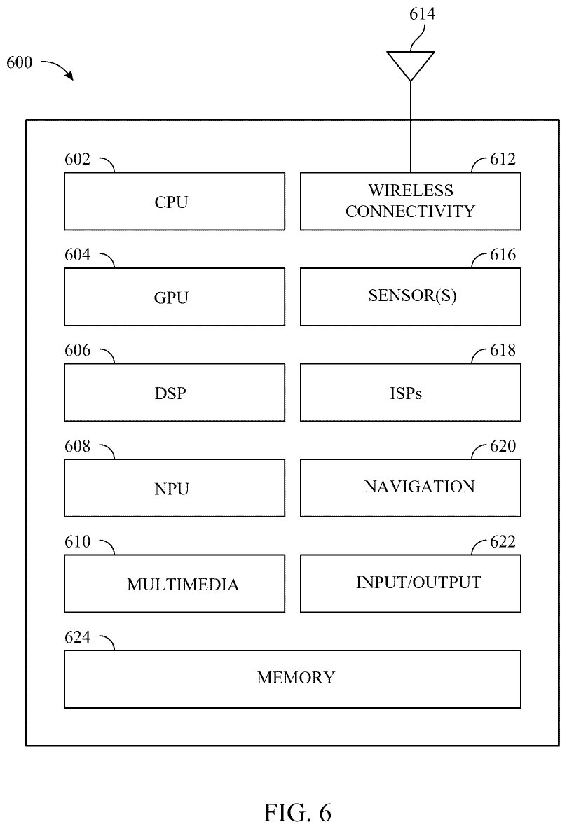

In some aspects, the heterogeneous computing system 200 discussed above with reference to FIG. 1 may be included in a device or processing system. FIG. 6 depicts an example processing system 600. Although depicted as a single system for conceptual clarity, in some aspects, as discussed above, the operations described below with respect to the processing system 600 may be distributed across any number of devices or systems.

The processing system 600 includes a central processing unit (CPU) 602. Instructions executed at the CPU 602 may be loaded, for example, from a memory 624 associated with the CPU 602.

The processing system 600 also includes additional processing components tailored to specific functions, such as a graphics processing unit (GPU) 604, a digital signal processor (DSP) 606, a neural processing unit (NPU) 608, a multimedia component 610 (e.g., a multimedia processing unit), and a wireless connectivity component 612.

An NPU, such as NPU 608, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 608, are configured to accelerate the performance of common machine learning tasks, such as image classification, machine translation, object detection, and various other predictive models. In some examples, a plurality of NPUs may be instantiated on a single chip, such as a SoC, while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 608 is a part of one or more of the CPU 602, the GPU 604, and/or the DSP 606.

In some examples, the wireless connectivity component 612 may include subcomponents, for example, for third generation (3G) connectivity, fourth generation (4G) connectivity (e.g., 4G Long-Term Evolution (LTE)), fifth generation connectivity (e.g., 5G or New Radio (NR)), Wi-Fi connectivity, Bluetooth connectivity, and/or other wireless data transmission standards. The wireless connectivity component 612 is further coupled to one or more antennas 614.

The processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS), as well as inertial positioning system components.

The processing system 600 may also include one or more input and/or output devices 622, such as screens, touch-sensitive surfaces (including touch-sensitive displays), physical buttons, speakers, microphones, and the like.

In some examples, one or more of the processors of the processing system 600 may be based on an ARM or RISC-V instruction set.

The processing system 600 also includes the memory 624, which is representative of one or more static and/or dynamic memories, such as a dynamic random access memory, a flash-based static memory, and the like. In this example, the memory 624 includes computer-executable components, which may be executed by one or more of the aforementioned processors of the processing system 600.

Generally, the processing system 600 and/or components thereof may be configured to perform the methods described herein.

Notably, in other aspects, elements of the processing system 600 may be omitted, such as where the processing system 600 is a server computer or the like. For example, the multimedia component 610, the wireless connectivity component 612, the sensor processing units 616, the ISPs 618, and/or the navigation processor 620 may be omitted in other aspects. Further, aspects of the processing system 600 may be distributed between multiple devices.

### Example Clauses

In addition to the various aspects described above, specific combinations of aspects are within the scope of the disclosure, some of which are detailed below:

Aspect 1: A method for computing a fractional exponential, comprising: applying a binary scaling operation to a plurality of logits to generate a plurality of scaled logits; applying, by a hardware accelerator configured for matrix multiplication, a polynomial convert function to each of the plurality of scaled logits; and obtaining, via the hardware accelerator, feedback based on applying the polynomial convert function, the feedback comprising a fractional exponential for each of the plurality of scaled logits.

Aspect 2: The method of Aspect 1, wherein applying the polynomial convert function comprises performing one or more operations to facilitate applying the polynomial convert function to the plurality of scaled logits.

Aspect 3: The method of Aspect 2, wherein the one or more operations comprises applying a shift to an accumulator of the hardware accelerator to discard an integer portion of each of the plurality of scaled logits.

Aspect 4: The method of Aspect 3, wherein the shift comprises a left-shift.

Aspect 5: The method of Aspect 3, wherein the one or more operations further comprise activating a function of the hardware accelerator to prevent the accumulator from being saturated while the shift is applied to the accumulator.

Aspect 6: The method of Aspect 2, wherein the one or more operations comprise configuring a rounding operation associated with the polynomial convert function.

Aspect 7: The method of Aspect 6, wherein configuring the rounding operation comprises deactivating the rounding operation.

Aspect 8: The method of Aspect 2, wherein the one or more operations comprise disabling data path shaping.

Aspect 9: The method of any of Aspects 1-8, wherein the plurality of scaled logits comprise an integer portion and a fractional portion, and wherein applying the polynomial convert function to the plurality of scaled logits comprises applying the polynomial convert function to the fractional portion of each of the plurality of scaled logits.

Aspect 10: A hardware accelerator for computing a fractional exponential, the hardware accelerator comprising: a systolic array comprising a plurality of systolic stages, each of the plurality of systolic stages comprising a plurality of processing elements, each of the processing elements comprising a multiplier and an accumulator, wherein the hardware accelerator is configured to: apply a binary scaling operation to a plurality of logits to generate a plurality of scaled logits; apply a polynomial convert function to each of the plurality of scaled logits; and obtain feedback based on applying the polynomial convert function, the feedback comprising a fractional exponential for each of the plurality of scaled logits.

Aspect 11: The hardware accelerator of Aspect 10, wherein to apply the polynomial convert function, the hardware accelerator is configured to perform one or more operations to facilitate applying the polynomial convert function to the plurality of scaled logits.

Aspect 12: The hardware accelerator of Aspect 11, wherein the one or more operations comprises applying a shift to the accumulator to discard an integer portion of each of the plurality of scaled logits.

Aspect 13: The hardware accelerator of Aspect 12, wherein the shift comprises a left-shift.

Aspect 14: The hardware accelerator of Aspect 12, wherein the one or more operations further comprise activating a function of the hardware accelerator to prevent the accumulator from being saturated while the shift is applied to the accumulator.

Aspect 15: The hardware accelerator of Aspect 11, wherein the one or more operations comprise configuring a rounding operation associated with the polynomial convert function.

Aspect 16: The hardware accelerator of Aspect 15, wherein configuring the rounding operation comprises deactivating the rounding operation.

Aspect 17: The hardware accelerator of Aspect 10, wherein the one or more operations comprise disabling data path shaping.

Aspect 18: The hardware accelerator of Aspect 10, wherein the plurality of scaled logits comprise an integer portion and a fractional portion, and wherein to apply the polynomial convert function to the plurality of scaled logits, the hardware accelerator is configured to apply the polynomial convert function to the fractional portion of each of the plurality of scaled logits.

Aspect 19: An apparatus comprising: means for applying a binary scaling operation to a plurality of logits to generate a plurality of scaled logits; means for applying a polynomial convert function to each of the plurality of scaled logits; and means for obtaining feedback based on applying the polynomial convert function, the feedback comprising a fractional exponential for each of the plurality of scaled logits.

Aspect 20. The apparatus of Aspect 19, wherein the plurality of scaled logits comprise an integer portion and a fractional portion, and wherein applying the polynomial convert function to the plurality of scaled logits comprises applying the polynomial convert function to the fractional portion of each of the plurality of scaled logits.

### Additional Considerations

The various operations of methods described above may be performed by any suitable means capable of performing the corresponding functions. The means may include various hardware and/or software components(s) module(s), including, but not limited to a circuit or processor. Generally, where there are operations illustrated in figures, those operations may have corresponding counterpart means-plus-function components with similar numbering.

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for computing a fractional exponential, comprising:
applying a binary scaling operation to a plurality of logits to generate a plurality of scaled logits;
applying, by a hardware accelerator configured for matrix multiplication, a polynomial convert function to each of the plurality of scaled logits; and
obtaining, via the hardware accelerator, feedback based on applying the polynomial convert function, the feedback comprising a fractional exponential for each of the plurality of scaled logits.

2. The method of claim 1, wherein applying the polynomial convert function comprises performing one or more operations to facilitate applying the polynomial convert function to the plurality of scaled logits.

3. The method of claim 2, wherein the one or more operations comprises applying a shift to an accumulator of the hardware accelerator to discard an integer portion of each of the plurality of scaled logits.

4. The method of claim 3, wherein the shift comprises a left-shift.

5. The method of claim 3, wherein the one or more operations further comprise activating a function of the hardware accelerator to prevent the accumulator from being saturated while the shift is applied to the accumulator.

6. The method of claim 2, wherein the one or more operations comprise configuring a rounding operation associated with the polynomial convert function.

7. The method of claim 6, wherein configuring the rounding operation comprises deactivating the rounding operation.

8. The method of claim 2, wherein the one or more operations comprise disabling data path shaping.

9. The method of claim 1, wherein the plurality of scaled logits comprise an integer portion and a fractional portion, and wherein applying the polynomial convert function to the plurality of scaled logits comprises applying the polynomial convert function to the fractional portion of each of the plurality of scaled logits.

10. A hardware accelerator for computing a fractional exponential, the hardware accelerator comprising:
a systolic array comprising a plurality of systolic stages, each of the plurality of systolic stages comprising a plurality of processing elements, each of the processing elements comprising a multiplier and an accumulator,
wherein the hardware accelerator is configured to:
apply a binary scaling operation to a plurality of logits to generate a plurality of scaled logits;
apply a polynomial convert function to each of the plurality of scaled logits; and
obtain feedback based on applying the polynomial convert function, the feedback comprising a fractional exponential for each of the plurality of scaled logits.

11. The hardware accelerator of claim 10, wherein to apply the polynomial convert function, the hardware accelerator is configured to perform one or more operations to facilitate applying the polynomial convert function to the plurality of scaled logits.

12. The hardware accelerator of claim 11, wherein the one or more operations comprises applying a shift to the accumulator to discard an integer portion of each of the plurality of scaled logits.

13. The hardware accelerator of claim 12, wherein the shift comprises a left-shift.

14. The hardware accelerator of claim 12, wherein the one or more operations further comprise activating a function of the hardware accelerator to prevent the accumulator from being saturated while the shift is applied to the accumulator.

15. The hardware accelerator of claim 11, wherein the one or more operations comprise configuring a rounding operation associated with the polynomial convert function.

16. The hardware accelerator of claim 15, wherein configuring the rounding operation comprises deactivating the rounding operation.

17. The hardware accelerator of claim 11, wherein the one or more operations comprise disabling data path shaping.

18. The hardware accelerator of claim 10, wherein the plurality of scaled logits comprise an integer portion and a fractional portion, and wherein to apply the polynomial convert function to the plurality of scaled logits, the hardware accelerator is configured to apply the polynomial convert function to the fractional portion of each of the plurality of scaled logits.

19. An apparatus comprising:
means for applying a binary scaling operation to a plurality of logits to generate a plurality of scaled logits;
means for applying a polynomial convert function to each of the plurality of scaled logits; and
means for obtaining feedback based on applying the polynomial convert function, the feedback comprising a fractional exponential for each of the plurality of scaled logits.

20. The apparatus of claim 19, wherein the plurality of scaled logits comprise an integer portion and a fractional portion, and wherein applying the polynomial convert function to the plurality of scaled logits comprises applying the polynomial convert function to the fractional portion of each of the plurality of scaled logits.
